(19) United States
(12) Patent Application Publication
(10) Pub. No.: US 2023/0137191 A1
(43) Pub. Date: May 4, 2023

(54) MECHANISM TO RECOMPOSE WORKLOAD PACKAGES IN A COMPUTING ENVIRONMENT

(71) Applicants: Adrian C. Hoban, Cratloe (IE); Thijs Metsch, Bruehl (DE); John J. Browne, Limerick (IE); Kshitij A. Doshi, Tempe, AZ (US); Francesc Guim Bernat, Barcelona (ES); Anand Haridass, Bengaluru (IN); Chris M. MacNamara, Ballyclough (IE); Amruta Misra, Bangalore (IN); Vikrant Thigle, Bengaluru (IN)

(72) Inventors: Adrian C. Hoban, Cratloe (IE); Thijs Metsch, Bruehl (DE); John J. Browne, Limerick (IE); Kshitij A. Doshi, Tempe, AZ (US); Francesc Guim Bernat, Barcelona (ES); Anand Haridass, Bengaluru (IN); Chris M. MacNamara, Ballyclough (IE); Amruta Misra, Bangalore (IN); Vikrant Thigle, Bengaluru (IN)

(21) Appl. No.: 18/089,022

(22) Filed: Dec. 27, 2022

(30) Foreign Application Priority Data
Nov. 12, 2022 (IN) 202241064894

(51) Int. Cl. G06F 9/50

(52) U.S. Cl. CPC G06F 9/5033; G06F 9/5044; G06F 9/5094

(57) ABSTRACT

An apparatus of a computing node of a computing network, a method to be performed at the apparatus, one or more computer-readable storage media storing instructions to be implemented at the apparatus, and a system including the apparatus. The apparatus includes a processing circuitry to: receive, from an orchestration block, a first workload (WL) package including a WL and first computing resource (CR) metadata; recompose the first WL package into a second WL package that includes the WL and second CR metadata that is different from the first CR metadata, is based at least in part on CR information regarding a server architecture onto which the WL is to be deployed, and is further to indicate one or more processors of the server architecture onto which the WL is to be deployed; and send the second WL package to one or more processors of the server architecture for deployment of the WL thereon.

### RELATED APPLICATIONS

This application claims benefit of and priority under 35 U.S.C. 119 to Indian Provisional Patent Application Serial No. 202241064894, filed Nov. 12, 2022, entitled “MECHANISM TO RECOMPOSE WORKLOAD PACKAGES IN A COMPUTING ENVIRONMENT” which is incorporated by reference herein in its entirety.

### FIELD

The present disclosure relates in general to the field of computer architecture, and more specifically, though not exclusively, to server architectures or server boards in a computing environment, such as in a data center.

### BACKGROUND

When workload packages (WL packages) are dispatched to a server architecture for deployment at the server architecture, such WL packages may include computing resource metadata, such as metadata that that pertains to WL package deployment resource requirements at the server architecture. The computing resource (CR) metadata may include, for example, metadata based on a number of processor cores (or cores) needed, size of memory, etc. Based on a Kubernetes orchestration regime, the CR metadata may include burstable information, such as a minimum or maximum number of cores needed, and/or a minimum or maximum size of memory needed. Based on a Kubernetes orchestration regime, the CR metadata may include guaranteed Quality of Service (QoS) information, such as an explicit number of cores needed, and/or an explicit size of memory.

### BRIEF DESCRIPTION OF THE DRAWINGS

FIG. 1 is a table of some Performance, Dependability, and Security (PDS) related parameters from the standpoint of the service owner and that of the resource owner in a computing environment, such as a data center

FIG. 2 is a diagram of an example computing environment to perform a method according to some embodiments.

FIG. 3 is a flowchart of a method according to some embodiments, which may be used on the computing environment of FIG. 2.

FIG. 4 is a flow of information or signals between tiles, monitoring block, WL composition block, OS block and orchestration block of the computing environment of FIG. 2 according to an embodiment.

FIG. 5 is a flow based on usability information regarding CR components, such as CR components associated with FIG. 2, according to an embodiment.

FIG. 6 is a diagram of a process flow according to one embodiment.

### DETAILED DESCRIPTION

Some embodiments provide a mechanism to recompose (or repackage) a to-be-deployed workload based on tiles of a multi-tile architecture that is to deploy (e.g., execute) the workload.

Some embodiments further provide a mechanism to recompose (or repackage) tiles of a multi-tile architecture based on monitored consumption patterns of resources corresponding to the tiles.

Some embodiments further include a mechanism to cause a smart placement of workloads onto the tiles.

In order to implement any of the example mechanisms noted above, some embodiments include using a software agent or processing unit firmware running in the background of an operating system (0S)/hypervisor and/or in the orchestrator of a data center. Parts associated with some embodiments may be implemented as a hardware (HW) IP block.

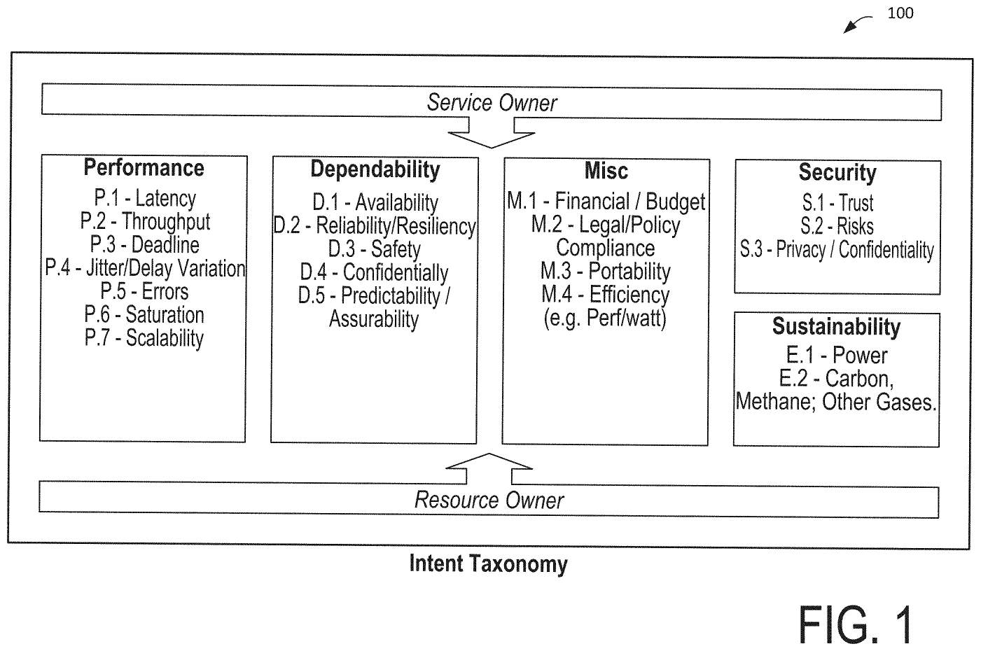

Reference is now made to FIG. 1, which shows a table 100 of some Performance, Dependability, and Security (PDS) related parameters from the standpoint of the service owner and that of the resource owner in a computing environment, such as a data center. Some embodiments are to be based on affecting and/or improving some of the PDS parameters shown in FIG. 1. Such parameters include performance, dependability, security, sustainability and/or others. Performance parameters include at least one of latency, throughput, deadline, jitter/delay variation, errors, saturation, or scalability. Dependability includes at least one of availability, reliability/resiliency, safety, confidentiality, predictability/assure, or ability. Security includes at least one of trust, risks, or privacy/confidentiality. Sustainability includes at least one of power, or carbon, methane, and or other gases. Miscellaneous other parameters include at least one of financial/budget, legal/policy compliance, portability, or efficiency (e.g., performance/wattage).

Some data center server systems correspond to Non-Uniform Memory Access (NUMA) systems. In a NUMA system, each Central Processing Unit (CPU) may contain its own memory controllers that provide access to locally connected memory, and it can also access the memory connected and controlled by a remote CPU. There is a difference in latency and bandwidth between reading and writing, by a CPU, of local and remote memory, hence the term Non-Uniform Memory Access (NUMA).

The state of the art provides workload packages (or workloads) for deployment without detailed awareness of the architecture on which the workloads will be running. This lack of awareness means the workloads' allocation to infrastructure may be sub-optimal. For example, WL allocation may span Sub-NUMA Cluster (SNC) domains, resulting in possibly sub-optimal performance and scaling points as well as the possibility of stranded resources. Recall that sub-NUMA Clustering divides the cores, cache, and memory of a processing circuitry that corresponds to a NUMA system into multiple NUMA domains. Even if the workload could be packaged for deployment with an awareness of the architecture onto which it is to be deployed, it would not be practical today to manage the offline composition of many workloads based on different target environments (architectures onto which the workloads are to be deployed) that need to be supported.

The above problem is exacerbated as the industry moves to tile based multi-tile architectures for all types of Processing Units (PUs). In these architectures, which involve the use of technology such as 3-D stacking of the tiles (or chiplets) built on top of a ‘base’ die, workload placement on cores (that belong to different chiplets or tiles) will have to take into consideration interaction with their respective caches/mesh/Input/Output (PO), and, moreover, must deal with power/thermal characteristics of the ‘neighborhood’ on the base-die supporting the tiles. The variations based on the interactions of tile cores with their respective caches/mesh/PO and on the power and/or thermal characteristics of the base-die environment have additional impact on performance corresponding to deployment and execution of a workload.

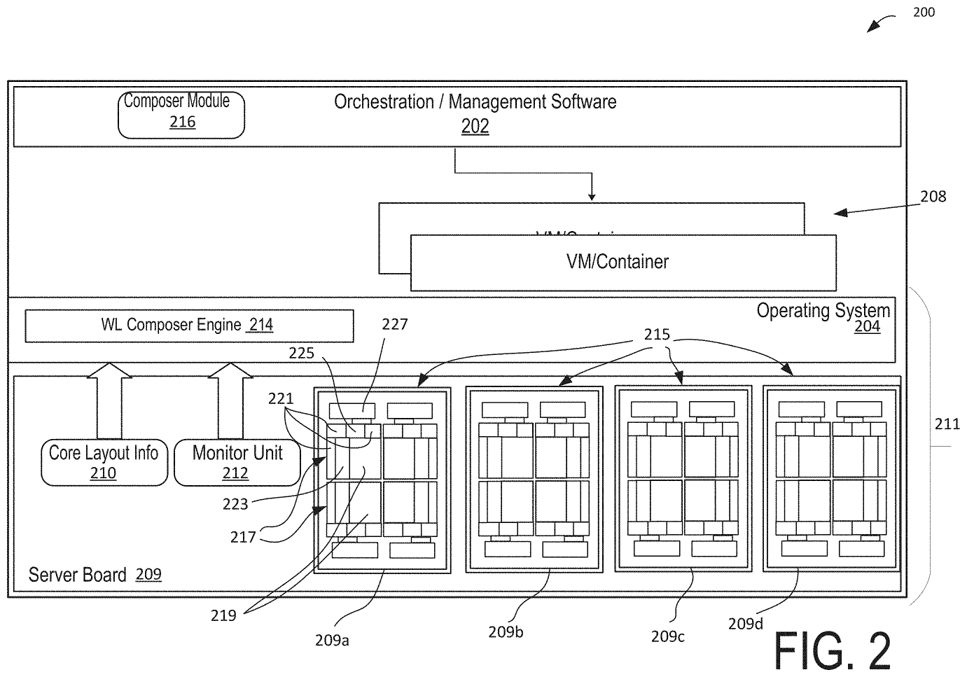

As referred to herein, a “component” of a server architecture may correspond to a circuitry to perform a function, such as an Application Specific Integrated Circuit (ASIC) of the server architecture, such as circuitry for compute, storage, GPU, network, or cooling, power, etc. as mentioned above. A “component” as referred to herein may for example correspond to a physical resource within the server architecture as described in further detail below in the context of example architectures of FIGS. 2, 3 and 4.

Individual components may be associated with their corresponding circuit board (or “circuit board”). For example, a circuit board may correspond to a motherboard, a backboard, a PCIe extender circuit board (e.g., with a re-timer functionality), or any physical circuit board.

A “tile” or “chiplet” as referred to herein may include a one or more cores, one or more accelerators, I/O ports, such as I/O ports compliant with CXL, PCIe and/or UPI, and memory circuitry such as cache memory by way of example. Each tile may also include one or more switches, for example a switch per core, to connect to switches of other cores in other tiles using a mesh network.

A “multi-tile” architecture or processor as referred to herein may include a substrate and a plurality of interconnected tiles on a base die to form the multi-tile architecture or multi-tile processor (MTP). The MTP may include a one-dimensional array or two-dimensional arrays of tiles, where the tiles may or may not be identical. The tiles may be coupled to one another using a mesh network, for example by way of switches on corresponding cores of the tiles, and by way of tile interconnects interconnecting tiles to one another within the base die, for example in a non-hierarchical or hierarchical manner. The tile interconnects may be embodied, by way of example, as embedded multi-die interconnect bridges (EMIBs) or other chiplet to chiplet interconnects.

A “computing node” as referred to herein may be embodied as any type of component, device, appliance, or other thing capable of communicating as a producer or consumer of data in a computing environment (or computing network, such as a data center or a cloud network, by way of example). Further, the label “node” or “device” herein does not necessarily mean that such node or device operates in a client or agent/minion/follower role; rather, any of the nodes or devices in a computing environment may refer to individual entities, nodes, or subsystems which include discrete or connected hardware or software configurations to facilitate or use of the computing environment. A computing node as referred to herein may, for example, include a server architecture. A computing node as referred to herein may, for example, include a network switch, a storage unit, an xPU such as a central processing unit (CPU), an infrastructure processing unit (IPU), etc. A computing node as referred to herein may include, for example, a field programmable gate array (FPGA) or an application specific integrated circuit (ASIC).

A “server architecture” as referred to herein may include a processing circuitry, which may include one or more processors, for example one or more MTPs, for example, anywhere from 2 to 8 MTPs, which may be interconnected with one another by way of interconnects, such as interconnects in the base die. The processing circuitry of a server architecture according to some embodiments may be coupled to an input and to an output, may receive data through the input, and send data through the output.

An “orchestration block” as used herein may include functionality to perform orchestration functions **,

A “CR component” as referred to herein refers to any HW-based computing resource component, such as a processor, a tile/chiplet, a core, or a memory circuitry.

According to a first example, some embodiments include repackaging/re-composition of the workload package such that the workload better fits within tiles of a MTP.

According to a second example, some embodiments include repackaging/re-composition of “tiles” of a MTP based on consumption patterns at tiles of a MTP.

According to a third example, some examples include smart placement of workloads onto “tiles” of a MTP.

According to some embodiments, a WL package received in a first package for deployment on a server architecture may be recomposed into a second WL package in a second package where the CR metadata of the second package is different from that associated with the first package, and where the CR metadata of the second package is based on computing resources of the server architecture.

It is not practical to expect application developers to build WL packages that can be efficiently deployed on all available configurations of process unit XPU (e.g., CPU, GPU, . . . ) chiplet/tiles. Some embodiments remove a need for the application developer to build and maintain current knowledge regarding possible target environments for deployment of respective WL packages.

Some embodiments may address the above problem by recomposing a WL package based on an awareness to the WL package's target environment, where recomposing may include a change in the CR metadata of the WL package. Some embodiments address the problem of the deployment of a WL package onto a computing environment including 2-D and 3-D stacked dies in a MTP. Some embodiments recompose the WL package based on power and/or thermal parameters of the target computing resources, for example by mapping a WL package or parts of the WL package to target computing resources based on the power and/or thermal parameters.

Some embodiments may lead to improved performance for the International Standardization Organization (ISO) power on disaggregated MTPs as well as more effective WL package scale points. Some embodiments may support the avoidance of stranded resources on a server architecture by both rightsizing a WL package for the tiles of the server architecture, and optionally, by adjusting the logical composition of the tiles for the WL package.

Some embodiments may rely on a software agents or XPU firmware running in the background of an operating system (OS)Hypervisor and in an orchestrator of a computing environment, similar for example to that shown in FIG. 2. Parts may be implemented as a HW IP block.

Reference is now made to FIG. 2, which shows a network 200 of functional blocks of a computing environment such as a data center. Network 200 includes an orchestration/management functional block (orchestration block) 202, which may be implemented in a first computing node of the computing environment, or which may be implemented across a number of computing nodes of the computing environment. Orchestration block 202 may include a composer module or block 216 that is to compose a WL package for deployment at a server architecture. The orchestration block 202 may send WL packages for execution by way of virtual machines (VMs) or containers (VMs/containers), microservices, or sidecars, which may be contained in any of the noted mechanisms.

A “sidecar” as used herein may refer to a separate container that runs alongside an application container in a Kubernetes pod, for example serving as a helper application. The sidecar may, by way of example, be responsible for offloading, from the applications themselves, functions required by the applications within a service mesh, for example Secure Socket Layer (SSL)/mutual Transport Layer Security (mTLS), traffic routing, high availability, etc., and further for implementing deployment testing patterns such as circuit breaker, canary, and blue-green. Sidecars may for example be used to aggregate and format log messages from multiple application instances into a single file. As data-plane components, sidecars may be managed by a control plane within the service mesh. While a sidecar may route application traffic and provide other data-plane services, the control plane may inject sidecars into a pod when necessary, and perform administrative tasks, such as renewing mTLS certificates and pushing them to the appropriate sidecars as needed.

An operating system (OS) block 204 may be in communication with the orchestration block 202 through the fabric of the computing environment. The OS block 204 may, for example, be implemented at a server architecture of a second computing node of the computing environment, the second computing node being distinct from the first computing node that executes the orchestration block 202. OS block 204 may include a WL package Composer Engine (WCE) 214, which may be implemented in the second computing node in order to recompose a WL package received from the orchestration block 202 according to some embodiments. A server architecture 209 of the network 200 may include the OS block 204, and one or more processors, for example in the form of one or more MTPs. In the shown embodiment of FIG. 2, the computing cores may be implemented at a server architecture 209, such as one that includes four MTPs 209a, 209b, 209c and 209d.

The various functional blocks of the network 200 may be in communication with one another using any appropriate mechanism, such as, by way of example, application programming interfaces (APIs). Some examples of API-based interactions include a ORCHESTRATION block 202 communicating with a server architecture 211, server architectures pinging each other, or applications interacting with OS block 204.

According to some embodiments, WL packages and/or metadata associated with a WL may be communication within a computing network using APIs.

Individual MTPs may include a grouping 215 of tiles or chiplets 217. A tile 217 may include a one or more cores 219, I/O ports 221, such as I/O ports compliant with CXL, PCIe and/or UPI, and memory circuitry such as cache memory by way of example. Each tile may also include a memory controller 223, an accelerator circuitry (or accelerator) 225, and one or more switches, for example a switch per core, to connect to switches of other cores in other tiles using a mesh network. Optionally, there may be high bandwidth memory (HBM) circuitries 227 embedded in respective ones of the tiles. An HBM circuitry may correspond to a fast DRAM, and may be used for WLs that require high bandwidth communication between a memory circuitry and the associated processing circuitries. An HBM circuitry may include a through silicon via stacked memory die on a tile.

The tiles may or may not be identical. The tiles may be coupled to one another using a mesh network, for example by way of switches on corresponding cores of the tiles, and by way of tile interconnects interconnecting tiles to one another within the base die, for example in a non-hierarchical or hierarchical manner. The tile interconnects may be embodied in the spaces between the tiles in a given MTP, and may further be embodied, by way of example, as embedded multi-die interconnect bridges (EMIBs) or other chiplet to chiplet interconnects.

Some embodiments include recomposing a first WL package addressed to a server architecture by an orchestration block, by one or more VMs, by one or more containers (such as Docker, an open source platform that enables developers to build, deploy, run, update and manage containers), by one or more sidecars and/or by one or more load balancers, into a second WL package based on an awareness of a tile architecture of one or more MTPs of the server architecture, and/or awareness of the CR information of the target environment for deployment of the WL. Embodiments encompass within their scope the provision of a first WL package to a server architecture directly from an orchestration block, directly from a load balancer, or through other functional blocks or components that may exist between the composer of the first WL package and the server architecture onto which the WL is to be deployed.

The server architecture 209 may implement a monitoring block 212, which may monitor and send parameters of or information regarding computing resources (CRs) of the server architecture 209, such parameters including, for example, number of MTPs, number of tiles per MTP, number of cores per tile, clock speed per MTP, cache size per MTP or per tile, thermal design power (TDP) per MTP or per tile, shared cache size among tiles of a MTP (e.g., last level cache (LLC) size as shared among tiles), number of memory controller per tile, number of channels per memory controller, cryptographic speed per accelerator per tile, compression speed per tile, decompression speed per tile, information regarding virtual machines or containers shared amongst tiles of a MTP, inference and/or artificial intelligence processing capabilities of a MTP, to name a few. The CR information may further include dynamic information regarding the server architecture, including, for example, at least one of thermal information or power information, or other similar dynamic information, as will be addressed in further detail in relation to the third embodiment further below.

The server architecture 209 may further implement a core layout information block which may access layout information regarding the computing resources of the server architecture 209, and which may send such information, for example to the WCE 214 of the OS block 204.

The OS block 204 and the server architecture 209 may be implemented in a single computing node 211 as shown, or, they may be disaggregated and be implemented in distinct computing nodes. The monitoring block 212 and/or core layout information block 210 may be implemented in a single circuitry of the server architecture 209, or they may be implemented in separate circuitries of the server architecture 209, for example in respective circuitries for respective ones of the MTPs 209a-209d.

WCE block or WCE 214 may be implemented in a same computing node as the OS block 204, or it may be implemented in circuitry separate from that computing node. According to an embodiment, several server architectures (not shown in FIG. 2) may share a same monitoring block, a same core layout information block, a same WCE block, or there may be a monitoring block, core layout information block, and/or WCE block per server architecture.

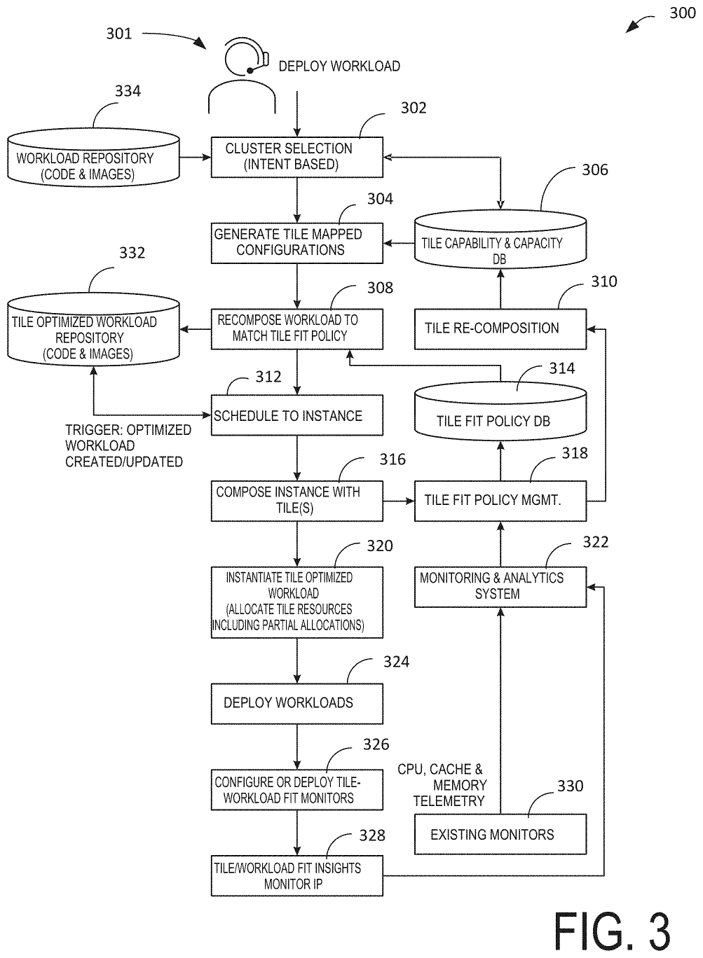

Operations concerning the first, second and third embodiments of the instant disclosure will now be described below in relation to FIGS. 3-8, with occasional reference to the computing environment of FIG. 2 by way of example.

Recall that, as stated above, a first embodiment includes repackaging/re-composition of the workload to better fit within tiles of a MTP, a second embodiment includes repackaging/re-composition of “tiles” of a MTP based on consumption patterns at tiles of a MTP, and a third embodiment includes smart placement of workloads onto “tiles” of a MTP.

### Embodiment One: Repackaging/Re-Composition of a WL Package to Better Fit within Tiles

According to a first embodiment, some examples include recomposing a WL package by changing the CR metadata associated therewith. For example, where a first WL package is sent, for example by an orchestration block (e.g., orchestration block 202 of FIG. 2), or by a load balancer, for deployment at a server architecture (e.g., server architecture 209 of FIG. 2), a WCE (e.g., WCE 214 of FIG. 2) may function of a “WL package modifier” to recompose the first WL package into a second WL package, where the second WL package includes the same WL package payload as the first WL package (e.g., pertains to execution of a same WL), but includes different CR metadata as compared with the first WL package.

The first CR metadata that is associated with the first WL package (which is to include a WL payload, or WL) may be included in the first WL package, or, alternatively, it may be accessed separately from accessing the first WL package. For example, one or more processors may determine the WL from the first WL package, and may determine the first CR metadata that is associated with the WL payload in a number of ways, such as from the first WL package, from another package separate from the first WL package, and/or by way of accessing a memory location, for example by way of accessing a look-up table that maps information about the WL as determined from the first WL package to first CR metadata to be associated with that WL. Although the description herein may emphasize a first WL package that itself includes the first CR metadata, embodiments are therefore not so limited, and include within their scope the recomposition of a first WL package into a different second WL package that has second CR metadata associated therewith, the second CR metadata different from the first CR metadata. Thus, embodiments further include within their scope the recomposition of CR metadata only, such that, for a determined WL from a WL package, one or more processors may forward the WL package for deployment at a server architecture, and recompose any first CR metadata associated with the WL into second CR metadata different from the first CR metadata, where the second CR metadata is based on CR information for the server architecture. The one or more processors may for example send the second CR metadata to the server architecture separately from the WL package, or may send the second CR metadata for storage at a memory location, such as within a look-up table. The look-up table may be accessible for deployment of the WL.

According to one embodiment the second CR metadata may be based on ensuring that

Through recomposition, where a the first WL package, based on a Kubernetes regime, may not be associated with first CR metadata, the second WL package may for example include CR metadata that is based on the computing resources of the server architecture. Through recomposition, where a the first WL package, based on a Kubernetes regime, may be associated with a first burstable CR metadata (e.g., a range of acceptable numbers of cores to execute the WL package, and/or a range of memory sizes to for execution of the WL package), the second WL package may for example include a second burstable CR metadata that is based on the computing resources of the server architecture. For example, through recomposition, where a the first WL package, based on a Kubernetes regime, may be associated with a first guaranteed QoS CR metadata (e.g., explicit number of cores and/or explicit size of memory), the second WL package may include second guaranteed QoS CR metadata that is based on the computing resources of the server architecture.

Reference is now made to FIG. 3, which shows a workflow 300 according to a first embodiment. Workflow 300 is to actively create a second WL package (or WL image) from a first WL package sent by an orchestration block of a computing environment, such as orchestration block 202 of FIG. 2. In the below description of FIG. 3, reference will be made to functional blocks or to physical blocks of FIG. 2 without referring each time to “FIG. 2” expressly.

At operation 301, a user, such as a service or application owner, may deploy a WL by providing the orchestration block 202 a pointer to a WL code repository within a memory of the corresponding computing environment. The pointer may, for example, provide a link to a GitHub or source repository, or a link to a docket hub or package/image repository. Thus, the WL code repository may include code for the WL package, or, optionally, a pre-created WL package.

The orchestration block 202 may then, at operation 302, for example using composer module 216, determine a WL package based on information in the WL code repository, and may provide the WL package to a computing node that includes the server architecture 209. The WL package may include a first WL package, to the extent that it is as of yet not recomposed (to happen later in the flow). The orchestration block 202 may select the computing node for example based on determining a Kubernetes cluster of computing nodes to deploy the WL of the WL package. The orchestration block 202 may select a computing node to deploy the WL of the first WL package based on knowledge regarding the computing nodes' general processing capabilities, such as on known tile capabilities of a server architecture's MTPs. For example, for a WL package with metadata indicating a 100 ms intent goal, the orchestration block 202 may select a high end server with advanced compute capabilities, whereas for a WL package with metadata indicating a best effort intent goal, the orchestration block 202 may be routed to a server architecture with less advanced computer capabilities, for example a lower number of computing cores.

At operation 304, the orchestration block 202 or OS block 204 may use a Tile Mapping Module (TMM: e.g., a functional block that maps a WL or parts of a WL of the first WL package to various tiles of the server architecture selected by the orchestration block 202 for deployment of the WL). The TMM is to generate a Tile Mapped Configuration (TMC) offering an initial, first view of the allocation of the WL to one or more tiles of the server architecture 209. Operation 304 may depend on accessing data in a database 306 regarding tile capabilities and tile capacity for the server architecture 209.

Operation 304 is not limited to execution in the orchestration block 202, but may be performed in whole or in part in the computing node 211 that houses the server architecture 209.

At operation 308, the orchestration block 202 or the OS block 204 may recompose the first WL package into a second WL package based on a tile fit policy (TFP). Operation 308 may for example be carried out by the WCE 214. The TFP may be accessed from a database of the computing environment. The second WL package may include second CR metadata that is different from any first CR metadata of the first WL package. The latter applies even where the first WL package does not include CL metadata. The tile fit policy may specify, for given WL parameters of the first WL package (for example similar to Kubernetes WL parameters mentioned above (including burstable parameters or guaranteed QoS, for example)), and for given CR information regarding the selected server architecture 209 (selected for example by the orchestration block 202 in operation 302), which of one or more tile(s) of the selected server architecture 209 may be used to deploy the WL.

The CR information regarding the selected server architecture 209 may be based on data regarding the MTP's of a server architecture, including number of MTPs, number of tiles per MTP, number of cores per tile, clock speed per MTP, cache size per MTP or per tile, thermal design power (TDP) per MTP or per tile, shared cache size among tiles of a MTP (e.g., last level cache (LLC) size as shared among tiles), number of memory controller per tile, number of channels per memory controller, cryptographic speed per accelerator per tile, compression speed per tile, decompression speed per tile, information regarding virtual machines or containers shared amongst tiles of a MTP, inference and/or artificial intelligence processing capabilities of a MTP, to name a few. The CR information may further include dynamic information regarding MTPs (including for example on a per tile and/or per core basis) of the server architecture, including at least one of thermal information or power information, or other similar dynamic information, as will be addressed in further detail in relation to the third embodiment further below.

The TFP within database 314 may be accessed by the orchestration block 202 or by the computing node 211 in order to recompose the WL into the second WL package at operation 308. As part of operation 308, the orchestration block 204 or computing node 211 may store a mapping of the WL to CRs of the server architecture 208 into a Tile Optimized Workload Repository (TOWR) 332, which may be stored locally with the WCE 214 that recomposes the WL.

At operation 312, the orchestration block 202 or the computing node 211 may schedule the second WL package to an instance of the WL, that is, the newly composed workload may be used as input to select the target deployment instance thereof. The instance may be securely composed with one or more tiles of the MTP, or it may be selected from pre-composed instances, as will be described in further detail below in relation to the second embodiment.

At operation 316, the orchestration block 202 or the computing node 211 may compose an instance of the second WL package with the tiles of server architecture 209.

At operation 320, the orchestration block 202 or the computing node 211 may instantiate on the tile-based instance of the second WL package by determining a full or partial allocation of tile resources (or CRs of the MTPs on the server architecture 209) to the WL of the second WL package, as will be described in further detail below in relation to the third embodiment.

At operation 324, after composing an instance of the second WL package with the tiles of the server architecture 209, and after determining an allocation of tile resources to the WL, the orchestration block 202 or the computing node 209 may

The orchestration block 202 or the computing node 209 may, at operation 326, configure or deploy a tile/WL fit monitoring engine, which may collect metrics regarding performance based on deployment of the WL.

The orchestration block 202 or the computing node 209 may, at operation 326, deploy a tile/WL fit insights engine, which is to determine insights from the data from the tile/WL fit monitoring engine in order to determine if the workload to tile mapping is a good fit. The insights may include, for example, suggestions as to best CR components to use to deploy a given type of WL.

The orchestration block 202 or the computing node 209 may then, at operation 328, feed insights from the tile/WL fit insights engine into a monitoring and analytics engine 322, which may be running on the orchestration block 202 or on the computing node 209.

At operation 330, monitor block 212 may send CR telemetry data, such as XPU, cache and memory data regarding the tiles of the server architecture 209, to the monitoring and analytics engine 322, which may use the telemetry data from operation 330, and the insights from the tile/WL fit insights engine, in order to determine analytics data therefrom, and to feed the data to a tile fit policy management engine 318, which may be running on either the orchestration block 202 or on the computing node 211. The tile fit policy management engine 318 may determine a tile fit policy based on input from the monitoring and analytics engine 322, which itself is based on input from both monitoring engine 212 of the server architecture 209, and optionally with other metrics, and tile workload fit data insights.

The orchestration block 202 or the computing node 209 may store the tile fit policy determined by the tile fit policy management engine at the tile fit policy database 314, which may be used to recompose WL packages as explained above in relation to operation 308. The tile fit policy management engine at 318 may use the insights from the tile/WL fit insights engine 328 to adjust an existing mapping between a WL and a tile allocation within the tile fit policy database 314. The tile fit policy management engine at 318 may use, at operation 310, the insights from the tile/WL fit insights engine 328 to implement a logical recomposition of the CR of the server architecture 209, as will be explained in further detail with respect to the third embodiment below.

Where tile recomposition is to take place at operation 310, it may occur based on an offline WL deployment event that is a function of past/historic similar WL deployments, after which, at runtime, a WL may be recomposed at operation 308 and allocated to tile resources at operation 320.

Alternatively, according to an “online” recomposition regime, an incoming first WL package may be at a first round, recomposed based on a best effort QoS regime initially, and deployed as such, and analytics collected from operation 318, based on which a next similar first WL package may be recomposed based on the analytics input of a last WL package recomposition round, further analytics collected such that each subsequent recomposition of a WL package is based on analytics data from a prior round of WL package recomposition.

Orchestration at the orchestration block 202 may be hierarchical in that a WL request may first be orchestrated at a given node that represents a system-of-systems (e.g., edge/cloud node); then be orchestrated at an individual site, and lastly at an individual computing node. Preferably, according to an embodiment, a complexity of hierarchical compositions of execution vehicles (nodes of the computing environment) may be reduced so that in a large scale software defined infrastructure, secure hierarchical compositions can be assembled quickly using smaller, uniform building blocks.

### Embodiment Two: Repackaging/Re-Composition of Computing Resources (CR) Based on Consumption Patterns

Recomposition of tiles of a server architecture, according to a second embodiment, and as illustrated by way of operation 310 of flow 300 of FIG. 3, may involve a dynamic reprovisioning of flexible logical interfaces or logical interconnects between tiles of the server architecture, such as between tiles of a same MTP, or between tiles of respective MTPs. Tile recomposition, for example based on operation 310, may allow a relatively rapid provisioning at runtime of large scale secure compositions of tiles. According to an embodiment, an overhead for reprovisioning tiles may be kept constant, that is, size independent, by the use of preassembled bins, or groupings, of tiles of different sizes. The different sizes may for example be expressed as k, k exp 2, k exp 4, etc., where k is a smallest unit of assembly of tiles, where k may signify, for example, a single large core, four smaller cores, 4 GB of dynamic random access memory (DRAM), etc. Each small unit k of assembly may include measured pieces that are attested and/or physical unclonable function (PUF)-verified. Resources such as host based memory circuitries (HBMs), for example HBMs 227, which may be competitively shared between tiles, or which may need to be assigned only in specialized use cases for given WLs, may be organized in bins or groupings separately in similar tile-hierarchies but with much smaller k-sizes, including the degenerate case of k=0.

As suggested by operation 310 of FIG. 3, tile re-composition may, where tile groupings (including memory circuitry groupings where applicable) pre-enqueue the groupings ahead of demand (that is, ahead of the next related WL deployment), for example based on a closed loop regime as a function of monitoring analytics data and tile fit policy management data from a running of prior similar WLs. A tile and memory grouping may for example specify that, for a certain type of WL, the HBM of tile 1 may be used along with cores of tile 2. This grouping may be split prior to WL execution (e.g., for the certain type of WL, the HBM of tile 2 may be used with cores 1 and 2 of tile 2, splitting out cores 3 and 4 of tile 2 for other uses), or the grouping may be subjected to a release of the CRs being used during deployment of a WL (e.g., for a WL being deployed and using the HBM of tile 1 with the cores of tile 2, the server architecture may implement a release of cores 3 and 4 of tile 2 for other uses). Thus, tile recomposition at operation 310 may further include splitting pre-assembled or pre-grouped tiles that were grouped in a last round at operation 310, and/or causing current execution vehicles to return/alter some fraction of their CR allocations for reassignment to other WLs. Tile recomposition that includes tile groupings involving a splitting pre-grouped tiles or releasing of already allocated tiles may, according to an embodiment, proceed with low overhead by setting thresholds to trigger splitting or releasing of CR resources, such that CR availability would not run into critically low levels. For example, a threshold may specify a threshold core utilization (e.g., in terms of utilization percentage) per tile or per core, beyond which a splitting of pre-grouped tiles or releasing of allocated tiles may need to be implemented.

According to an embodiment, the orchestration block 202 may flexibly assign unused or “waiting to be used” pre-groupings of CRs for best efforts WL deployments, finite duration tasks (such as for Function As A Service (FaaS) WL, preemptable services, and further as opaque accelerator stand-ins for other computations that may be offloaded.

According to the second embodiment, the orchestration block 202 or the computing node 211 may include logic to build new CR groupings (including cores, tiles and/or memory) or to select, offline or at runtime, from a catalogue of existing CR groupings for deployment of a WL based on WL type either. Some embodiments may include identifying given CR groupings (an example grouping including: cores 1, 3 and 5 of tile 1, core of tile 2, and HBM of tile 3) with corresponding metadata that is usable to allow selection of a given CR grouping for deployment of a WL. For example, CR metadata may be used to select a CR grouping based on metadata corresponding to the WL. For example, CR metadata may indicate a parameter of the CR grouping that may make it suitable for deployment of a given type of WL. For example, CR meta-data may indicate a CR grouping that supports data privacy, or low latency WLs, or ultra-low latency WLs. In addition, CR metadata may indicate whether the grouping is divisible/Not divisible. 3. Assembly deployment software that the orchestration can read an ‘assembly’ template for—and then ingest the assembly inventory lost for deployment.

### Embodiment Three: Smart Placement of Workloads onto Tiles

According to some embodiments, as part of tile recomposition, for example per operation 310 of FIG. 3, or after tile recomposition, a WL may be deployed onto CRs of a server architecture based on smart placement policies that may be thermal aware and/or power aware with respect to a thermal status and/or power status, respectively, of the tiles.

Although the third embodiment as described herein may focus on thermal and/or power aware WL placement, the third embodiment is not so limited, and pertains to smart placement based on any dynamic CR information, including at least one of the following statuses: power, temperature, humidity, fan speed, execution time (e.g., per WL), memory access response time (e.g., time from sending instruction to fetch data from a memory, and reception of the data), workload deployment response time (e.g., time from sending instruction to CRs to deploy a WL, and WL deployment), wear-and-tear, or battery life of MTP if applicable, etc.

According to some embodiments, the service owner of the computing environment, or the service provider, may further used to steer tile recomposition in the context of preferences regarding dynamic CR information. In addition to a service owner's criteria for mapping a WL to CRs, a resource owner's criteria and perspective may also come into play. A resource owner's criteria may include, for example, operation of the CRs in an efficient manner, for example based on the intent taxonomy set forth in FIG. 1 and described above. For example, a resource owner might suggest running the system in certain thermal ranges, so that the cooling loop/systems run most efficiently. An efficient running of CRs may be implemented not only on a per computing node level, but furthermore in multi-socket systems, in which liquid cooling may be looping over two CPUs, in which case the first socket might at a different temperature than the second socket by virtue of cooling inefficiencies and wear-and-tear reasons. Furthermore, wear-and-tear plays a role in which the resource owner might decide to run the system in a certain way for durability purposes.

According to some embodiments, supporting a wear-and-tear-based WL deployment placement decision, the orchestration block 202 may base its decision on wear-and-tear telemetry data. Wear-and-tear telemetry data, per MTP or per tile or per core, may include at least one of reliability, availability and serviceability (RAS) telemetry data, wear indicator data or stress threshold indicator data. RAS telemetry data may include cache BW, memory BW, number of cache misses, WLs deployed per time unit, number of hardware errors, percent of maximum compute headroom being used, temperature, humidity, power supply, voltage supply, fan speeds, etc. Wear indicator data (or “wear-and-tear data”) may include some of the RAS data, such as memory latency data, temperature, power and/or voltage data. Stress threshold indicator data may include overclocking, transistor aging, voltage spikes, temperature spikes, and/or hours used.

Thermal analyses of server architectures have indicated that, for different WLs, a temperature seen at individual tiles may be significantly different, with voltage maps for the same WLs roughly correlating with thermal hotspots on the tiles. For a typical system design, thermal and power controls may ensure that WL power is controlled to maximize performance of the CRs with respect to deployment of the WL while still meeting thermal specifications.

Let us now refer again to the computing environment 200 of FIG. 2, and to the monitoring block 212. On the base die, monitoring block 212 may collate real-time voltage and temperature data from multiple distributed spots across the die. The unit that implements the monitoring block 212 may be disposed on a given server architecture 209. There may be a monitoring unit at each tile, or one at each MTP, or a single one per server architecture. The monitoring block may provide information on the ‘local’ environment of the tile, for example on a per core basis. Voltage monitoring and/or temperature monitoring on the tiles themselves may provide more accurate information, however at an expense of added complexity in integration, particularly when heterogenous tiles are considered.

The monitoring block may also get ‘usage’ or wear-and-tear data from the different tiles. Based on the usage data, the monitoring unit, for example using the monitoring and analytics engine 322 of FIG. 3, may calculate the usability of a specific tile or core. This can be evaluated as a weighted sum of various dynamic core information, such as utilization, baseline memory latency, voltage, and/or temperature, depending on a usability policy set for each tile or on a per MTP or server architecture basis. The monitoring block may rank the cores based on their usability. The monitoring block 212 may also expose wear-and-tear telemetry data, where the wear-and-tear analysis may be performed at a MTP or at a server architecture itself or the wearing and aging of the tiles may be calculated from individual telemetry metrics as part of the monitoring and analytics engine, for example monitoring and analytics engine 322 of FIG. 3. The monitoring block 212 may be abstracted for example at the firmware level.

A monitoring unit that implements a monitoring block such as monitoring block 212 of FIG. 2 may include platform hardware, a basic input/output system (BIOS), an advanced configuration and power interface (ACPI) to the platform hardware, an ACPI interpreter interfacing with the ACPI interface, a device driver coupled to the platform hardware and to a kernel or hypervisor, with the system being managed at least in part by an orchestrator, such as orchestration block 202 of FIG. 2.

Referring now to the WCE block 214 of FIG. 2, this component can for example correspond to a system daemon that runs in the background and interacts with the OS or hypervisor. When a new WL is set to deploy, the orchestration block 202 may poll the monitoring block 212 for a ranked list of ‘usable’ cores. The WCE may determine the WL demand (# of cores) and provide these to the OS/hypervisor 204 as the CR to allocate to the WL.

When an orchestration block, such as Openstack and/or Kubernetes, is not aware of the exact core in a given XPU, the WCE may, according to an embodiment, implement an allocation policy that allocates free or lightly loaded cores for deployment of incoming WLs. The policy may for example depend on core ranking to achieve a desired result.

Alternatively, some embodiments provide for WL deployment allocation, for example by the orchestration block or by the computing node, based on dynamic CR information, at a per MTP granularity, per tile granularity or per core granularity. Dynamic CR information could include any of the example CR information parameters already noted above, such as, for example, temperature, power, voltage and/or percent utilization of a tile or of a core. The dynamic CR information may be used for tile recomposition, for example per operation 310 of FIG. 3 as described above, or for tile grouping splitting or CR releasing as part of tile recomposition, as also described above.

Thus, tile recomposition based on CR information may ‘move’ a WL to a more “usable” core/tile during run-time, as already described above. In such a case, the penalty of moving a WL to new CRs during runtime (e.g., the associated cache and memory footprint of such a move) may, according to an embodiment, also be accounted for in the “usability” factor with respect to each core in the context of moving a WL to the same. Thus, a core of CRs for WL deployment may be associated with a usability cost function in the context of moving a WL thereto during runtime.

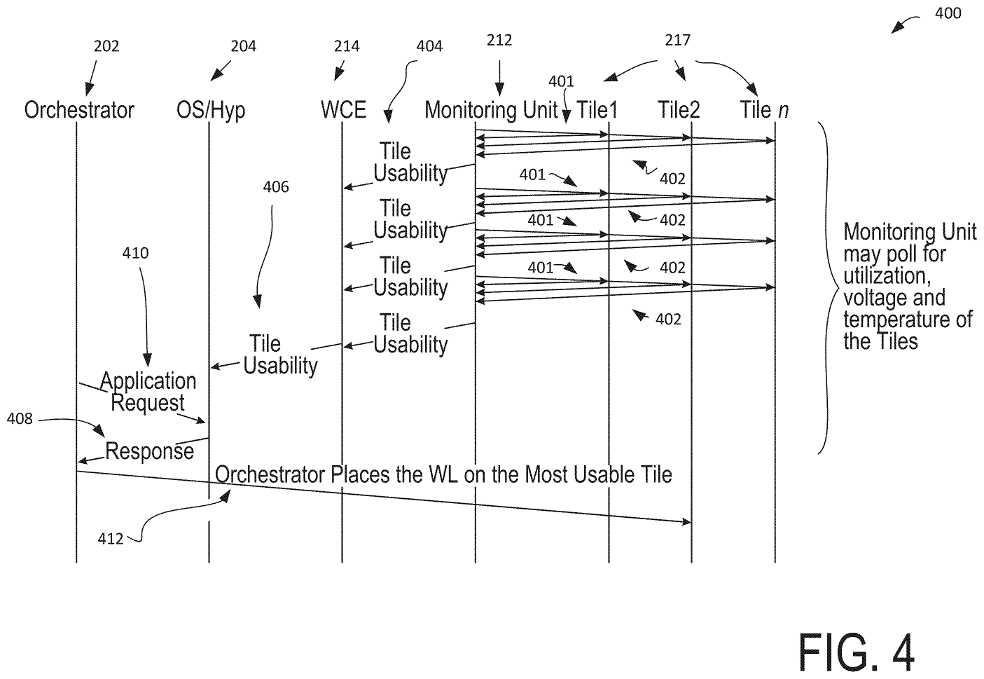

Reference is now made to FIG. 4, which shows a flow of information or signals between the tiles 215, monitoring block 212, WCE block 214, OS block 204 and orchestration block 202 of FIG. 2. The tiles 215 may provide their dynamic information 402 to the monitoring unit to implement monitoring block 212. For example, the monitoring unit may send requests 401 to each of the tiles. The monitoring block 212 may determine tile usability for individual ones of the tiles (or of the cores of the tiles) and send such tile usability information 404 to the WCE block 214. WCE block 214 may rank the tiles based on their usability information 404, and provide consolidated tile usability information data 406, for example including tile rankings, to the OS block 204. The OS block 204, upon receiving a WL package in the form of an application request 410 from the orchestration block 202, may send a response 408 to the orchestration block 202 based on the consolidated tile usability information data. For example, the consolidated tile usability information 406 may include a ranking of the tiles based on their appropriateness for allocation of the WL package for WL deployment based on dynamic CR information provided by each tile. The orchestration block 202 may then place at operation 412 the WL package for deployment on a tile that is ranked highest in terms of tile usability. Optionally, the orchestration block 202 may, according to the first embodiment described above, recompose the WL package in order to indicate CR metadata that corresponds to the tile with highest usability based on the consolidated usability information provided to the OS block 204.

For example, the monitoring block 212 may first poll the tiles for tile dynamic information, such as, as noted previously, temperature, power and/or voltage information. The tile usability information may for example be abstracted at the firmware level. For example, the WCE block 214 may take input from the monitoring block 212, and may further use the core layout information, in order to cause either a system administrator to manually place the WL onto the most usable tile, or to cause the composer module 216 to compose or recompose the WL package to place the WL onto the most usable tile, for example via the OS block 204 or via VM containers 208. The WCE may run as a daemon at the kernel level.

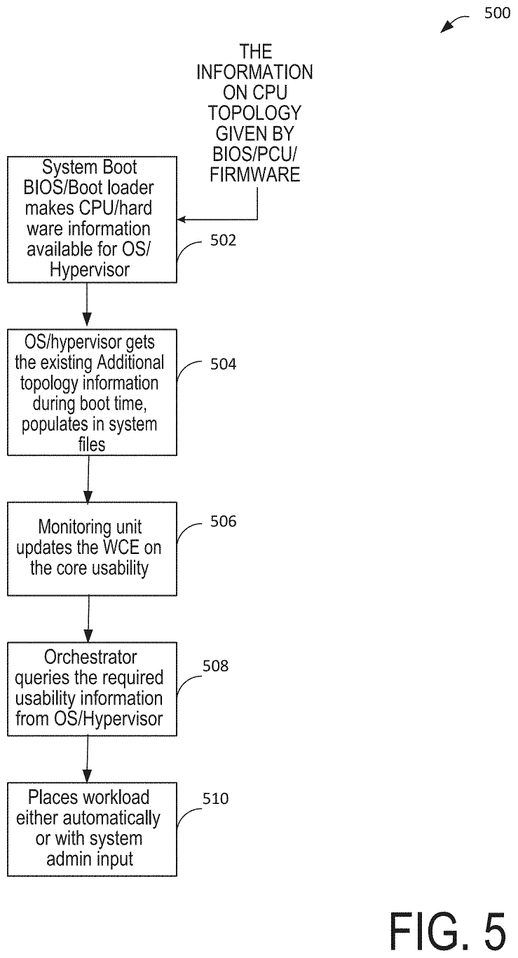

Reference is now made to FIG. 5, which shows a flow 500 based on core usability information (that is, at a granular level of cores instead of at a tile level as explained above in relation to the example of FIG. 4). The flow may be implemented at one or more computing nodes of a computing environment. In flow 500, at operation 502, the system boot BIOS or boot loader makes CR information, such as CPU or hardware information available to the OS/hypervisor block 204. At operation 504, the OS/hypervisor block 204 may receive additional existing CR topology information during boot time and may populate system files with this information. At operation 506, the monitoring block 212 may update the WCE block 214 with core usability data (see e.g., FIG. 4). At operation 508, the orchestration block 202 may query the OS/hypervisor block 204 regarding core usability information. At operation 510, at least one of the orchestration block 202, the OS/hypervisor block 204 or a component on the computing node 209 may place the WL either automatically or with system administrator input onto the most usable core(s).

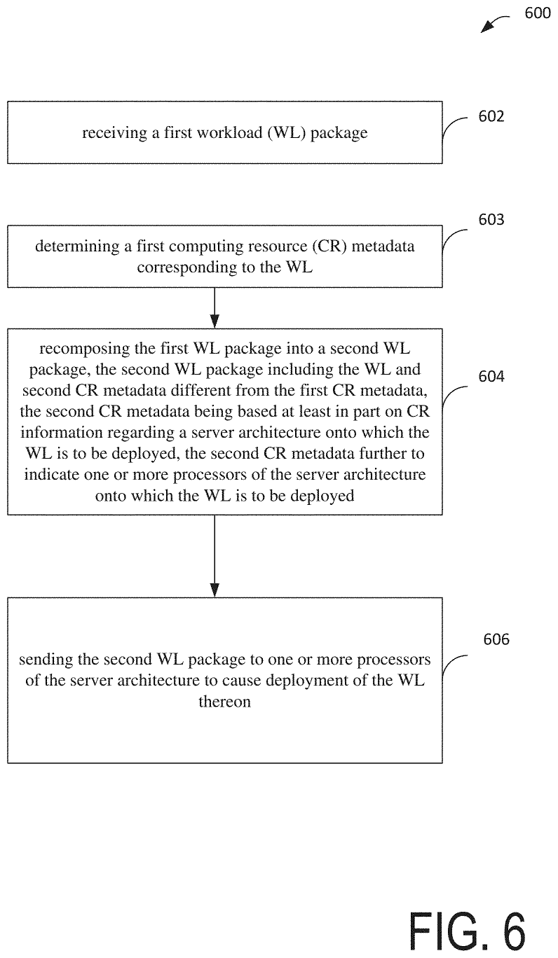

FIG. 6 is a process flow 600 according to an embodiment. Process flow 600 includes at operation 602, receiving a first workload (WL) package including a WL; and at operation 603, determining a first computing resource (CR) metadata corresponding to the WL. Process flow 600 includes at operation 604, recomposing the first WL package into a second WL package, the second WL package including the WL and second CR metadata different from the first CR metadata, the second CR metadata being based at least in part on CR information regarding a server architecture onto which the WL is to be deployed, the second CR metadata further to indicate one or more processors of the server architecture onto which the WL is to be deployed. Process flow 600 includes at operation 606, sending the second WL package to one or more processors of the server architecture to cause deployment of the WL thereon.

Embodiments herein may be implemented in various types of CR components, computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. It is noted that hardware, firmware and/or software elements may be collectively or individually referred to herein as “module,” or “logic.” A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable storage medium which represents various logic within the processor, which when read by a machine, computing device or system causes the machine, computing device or system to fabricate logic to perform the techniques described herein. Such representations, known as “IP cores,” may be stored on a tangible, machine readable storage medium and supplied to various customers or manufacturing facilities to load into the fabrication machines that actually make the logic or processor.

In further examples, a machine-readable medium also includes any tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., Hypertext Transfer Protocol (HTTP)).

A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for another. For example, descriptions using the terms “connected” and/or “coupled” may indicate that two or more elements are in direct physical or electrical contact with another. The term “coupled,” however, may also mean that two or more elements are not in direct contact with another, but yet still co-operate or interact with another.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Flow diagrams as illustrated herein provide examples of sequences of various process actions. The flow diagrams can indicate operations to be executed by a software or firmware routine, as well as physical operations. In some embodiments, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

Various components described herein can be a means for performing the operations or functions described. A component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, and so forth.

### EXAMPLES

Additional examples of the presently described method, system, and device embodiments include the following, non-limiting implementations. Each of the following non-limiting examples may stand on its own or may be combined in any permutation or combination with any one or more of the other examples provided below or throughout the present disclosure.

Example 1 includes an apparatus of a computing node of a computing network, the apparatus including: an input and an output; and a processing circuitry coupled to the input and to the output, the processing circuitry to: receive, at the input, a first workload (WL) package including a WL; determine a first computing resource (CR) metadata corresponding to the WL; recompose the first WL package into a second WL package, the second WL package including the WL and second CR metadata different from the first CR metadata, the second CR metadata being based at least in part on CR information regarding a server architecture onto which the WL is to be deployed, the second CR metadata further to indicate one or more processors of the server architecture onto which the WL is to be deployed; and send, from the output, the second WL package to one or more processors of the server architecture to cause deployment of the WL thereon.

Example 2 includes the subject matter of Example 1, wherein the CR information includes information on individual ones of the one or more processors, and on individual ones of interconnects between the one or more processors.

Example 3 includes the subject matter of Example 2, wherein the interconnects include respective embedded multi-die interconnect bridges.

Example 4 includes the subject matter of any one of Examples 1-3, wherein the CR information includes at least one of number of processors, number of cores per processor, memory size per processor, memory size per core, processor clock speed, core clock speed, number of memory controllers per processor, number of memory controllers per core, shared memory size between processors, shared memory size between cores, number of channels per memory controller, interconnect bandwidth between processors, interconnect communication latency between processors, number of accelerators per processor, number of accelerators per core, cryptographic speed per accelerator, compression speed per processor, compression speed per core, decompression speed per processor, decompression speed per core, or capability regarding machine-learning processing.

Example 5 includes the subject matter of any one of Examples 1-4, wherein the CR information includes dynamic CR information, the dynamic CR information including at least one of: power consumption per processor, power consumption per core, temperature per processor, temperature per core, humidity per processor, humidity per core, voltage per processor, voltage per core, fan speed per processor, execution time for a given WL per processor, execution time for a given WL per core, memory access response time per processor, memory access response time per core, WL deployment response time per processor, WL deployment response time per core, wear-and-tear per processor, wear-and-tear per core, or battery life per processor.

Example 6 includes the subject matter of Example 1, wherein: the one or more processors include a plurality of multi-tile processors (MTPs), individual ones of the MTPs including a plurality of tiles, individual ones of the tiles including one or more cores and one or more memory circuitries coupled to the one or more cores; and the CR information includes information regarding at least one of individual ones of the one or more tiles or individual ones of the one or more cores of said individual ones of the tiles.

Example 7 includes the subject matter of Example 6, wherein the CR information includes at least one of number of MTPs, number of tiles per MPT, number of cores per tile, memory size per MTP, memory size per tile, memory size per core, MTP clock speed, tile clock speed, core clock speed, number of memory controllers per MTP, number of memory controllers per tile, number of memory controllers per core, shared memory size between MTPs, shared memory size between tiles, shared memory size between cores, number of channels per memory controller, interconnect communication bandwidth between MTPs, interconnect communication bandwidth between tiles, interconnect communication bandwidth between cores, interconnect communication latency between MTPs, interconnect communication latency between tiles, interconnect communication latency between cores, number of accelerators per MTP, number of accelerators per tile, number of accelerators per core, cryptographic speed per accelerator, compression speed per MTP, compression speed per tile, compression speed per core, decompression speed per MTP, decompression speed per tile, decompression speed per core, or capability regarding machine-learning processing.

Example 8 includes the subject matter of Example 7, wherein the CR information further includes dynamic CR information, the dynamic CR information including: power consumption per MTP, power consumption per tile, power consumption per core, temperature per MTP, temperature per tile, temperature per core, humidity per MTP, humidity per tile, humidity per core, voltage per MTP, voltage per tile, voltage per core, fan speed per MTP, execution time for a given WL per MTP, execution time for a given WL per tile, execution time for a given WL per core, memory access response time per MTP, memory access response time per tile, memory access response per core, WL deployment response time per MTP, WL deployment response time per tile, WL deployment response time per core, wear-and-tear per MTP, wear-and-tear per tile, wear-and-tear per core, or battery life per MTP.

Example 9 includes the subject matter of any one of Examples 5 and 8, wherein the wear-and-tear includes information based on at least one of memory bandwidth availability, number of memory misses, number of WLs deployed per time unit, number of hardware errors, percent of maximum compute headroom being used, memory latency, overclocking, transistor aging, voltage spike, temperature spike, core utilization, one or more Reliability, Availability and Serviceability (RAS) indicators, workload key performance indicators (KPIs), power utilization, cache utilization, or hours used.

Example 10 includes the subject matter of Example 9, further including one or more monitoring units to determine the dynamic CR parameters, the processing circuitry to access the dynamic CR parameters from the one or more monitoring units.

Example 11 includes the subject matter of Example 10, wherein the processing circuitry is to access a tile fit policy to recompose the first WL package into the second WL package, the tile fit policy to indicate a mapping between respective types of WLs and respective CRs of the server architecture onto which the respective types of WLs are to be deployed.

Example 12 includes the subject matter of Example 11, wherein the tile fit policy is based on data from the one or more monitoring units and determined based on prior deployments of WLs at the server architecture.

Example 13 includes the subject matter of Example 12, wherein the data from the one or more monitoring units includes dynamic CR parameters.

Example 14 includes the subject matter of Example 12, wherein the respective CRs of the tile fit policy include respective groupings of CR components to which respective types of WLs are mapped, an individual grouping of CR components, the CR components including one or more processing components and one or more memory components, an individual processing component including one of a MTP, a tile or a core, and an individual memory component including a memory circuitry.

Example 15 includes the subject matter of any one of Examples 11-14, wherein the tile fit policy is a second tile fit policy, the processing circuitry to determine the second tile fit policy by changing a first tile fit policy to the second tile fit policy based on data from the one or more monitoring units.

Example 16 includes the subject matter of Example 15, wherein the respective groupings of CR components is a second respective groupings of CR components, the processing circuitry to determine the second tile fit policy by performing a recomposition of the CRs, performing the recomposition including changing a first respective groupings of CR components, based on data from the one or more monitoring units, to the second respective groupings of CR components.

Example 17 includes the subject matter of Example 16, wherein performing the recomposition includes splitting CR components, prior to deployment of the WL, from at least one grouping of the first respective groupings to determine the second respective groupings of CR components.

Example 18 includes the subject matter of Example 16, wherein performing the recomposition includes, during deployment of the WL, releasing CR components, from at least one grouping of the first respective groupings to determine the second respective groupings of CR components.

Example 19 includes the subject matter of any one of Examples 17 and 18, wherein the processing circuitry is to perform the recomposition based on monitoring analytics data, the monitoring analytics data based on respective usabilities of respective ones of the CR components.

Example 20 includes the subject matter of Example 19, wherein individual ones of the respective usabilities are based on a weighted sum of different types of CR information for a corresponding one of the CR components.

Example 21 includes the subject matter of Example 19, wherein individual ones of the respective usabilities are based on cost functions of releasing CR components from the first respective groupings of CR components.

Example 22 includes the subject matter of any one of Examples 1-21, the apparatus to further implement one of the orchestration block of the computing network, or at least one of an operating system block or server functions.

Example 23 includes the subject matter of any one of Examples 1-22, further comprising a communication interface to communicate with another computing node of the network, the communication interface including at least one of a wireless or a wired interface.

Example 24 includes a computing node of a computing network, the computing node including: a communication interface to communicate with other computing nodes of the computing network; and a processing circuitry coupled to the communication interface, the processing circuitry to: receive, at the input, a first workload (WL) package including a WL; determine a first computing resource (CR) metadata corresponding to the WL; recompose the first WL package into a second WL package, the second WL package including the WL and second CR metadata different from the first CR metadata, the second CR metadata being based at least in part on CR information regarding a server architecture onto which the WL is to be deployed, the second CR metadata further to indicate one or more processors of the server architecture onto which the WL is to be deployed; and send, from the output, the second WL package to one or more processors of the server architecture to cause deployment of the WL thereon.

Example 25 includes the subject matter of Example 24, wherein the CR information includes information on individual ones of the one or more processors, and on individual ones of interconnects between the one or more processors.

Example 26 includes the subject matter of Example 25, wherein the interconnects include respective embedded multi-die interconnect bridges.

Example 27 includes the subject matter of any one of Examples 24-26, wherein the CR information includes at least one of number of processors, number of cores per processor, memory size per processor, memory size per core, processor clock speed, core clock speed, number of memory controllers per processor, number of memory controllers per core, shared memory size between processors, shared memory size between cores, number of channels per memory controller, interconnect bandwidth between processors, interconnect communication latency between processors, number of accelerators per processor, number of accelerators per core, cryptographic speed per accelerator, compression speed per processor, compression speed per core, decompression speed per processor, decompression speed per core, or capability regarding machine-learning processing.

Example 28 includes the subject matter of any one of Examples 24-27, wherein the CR information includes dynamic CR information, the dynamic CR information including at least one of: power consumption per processor, power consumption per core, temperature per processor, temperature per core, humidity per processor, humidity per core, voltage per processor, voltage per core, fan speed per processor, execution time for a given WL per processor, execution time for a given WL per core, memory access response time per processor, memory access response time per core, WL deployment response time per processor, WL deployment response time per core, wear-and-tear per processor, wear-and-tear per core, or battery life per processor.

Example 29 includes the subject matter of Example 24, wherein: the one or more processors include a plurality of multi-tile processors (MTPs), individual ones of the MTPs including a plurality of tiles, individual ones of the tiles including one or more cores and one or more memory circuitries coupled to the one or more cores; and the CR information includes information regarding at least one of individual ones of the one or more tiles or individual ones of the one or more cores of said individual ones of the tiles.

Example 30 includes the subject matter of Example 29, wherein the CR information includes at least one of number of MTPs, number of tiles per MPT, number of cores per tile, memory size per MTP, memory size per tile, memory size per core, MTP clock speed, tile clock speed, core clock speed, number of memory controllers per MTP, number of memory controllers per tile, number of memory controllers per core, shared memory size between MTPs, shared memory size between tiles, shared memory size between cores, number of channels per memory controller, interconnect communication bandwidth between MTPs, interconnect communication bandwidth between tiles, interconnect communication bandwidth between cores, interconnect communication latency between MTPs, interconnect communication latency between tiles, interconnect communication latency between cores, number of accelerators per MTP, number of accelerators per tile, number of accelerators per core, cryptographic speed per accelerator, compression speed per MTP, compression speed per tile, compression speed per core, decompression speed per MTP, decompression speed per tile, decompression speed per core, or capability regarding machine-learning processing.

Example 31 includes the subject matter of Example 30, wherein the CR information further includes dynamic CR information, the dynamic CR information including: power consumption per MTP, power consumption per tile, power consumption per core, temperature per MTP, temperature per tile, temperature per core, humidity per MTP, humidity per tile, humidity per core, voltage per MTP, voltage per tile, voltage per core, fan speed per MTP, execution time for a given WL per MTP, execution time for a given WL per tile, execution time for a given WL per core, memory access response time per MTP, memory access response time per tile, memory access response per core, WL deployment response time per MTP, WL deployment response time per tile, WL deployment response time per core, wear-and-tear per MTP, wear-and-tear per tile, wear-and-tear per core, or battery life per MTP.

Example 32 includes the subject matter of any one of Examples 28 and 31, wherein the wear-and-tear includes information based on at least one of memory bandwidth availability, number of memory misses, number of WLs deployed per time unit, number of hardware errors, percent of maximum compute headroom being used, memory latency, overclocking, transistor aging, voltage spike, temperature spike, core utilization, one or more Reliability, Availability and Serviceability (RAS) indicators, workload key performance indicators (KPIs), power utilization, cache utilization, or hours used.

Example 33 includes the subject matter of Example 32, further including one or more monitoring units to determine the dynamic CR parameters, the processing circuitry to access the dynamic CR parameters from the one or more monitoring units.

Example 34 includes the subject matter of Example 33, wherein the processing circuitry is to access a tile fit policy to recompose the first WL package into the second WL package, the tile fit policy to indicate a mapping between respective types of WLs and respective CRs of the server architecture onto which the respective types of WLs are to be deployed.

Example 35 includes the subject matter of Example 34, wherein the tile fit policy is based on data from the one or more monitoring units and determined based on prior deployments of WLs at the server architecture.

Example 36 includes the subject matter of Example 35, wherein the data from the one or more monitoring units includes dynamic CR parameters.

Example 37 includes the subject matter of Example 35, wherein the respective CRs of the tile fit policy include respective groupings of CR components to which respective types of WLs are mapped, an individual grouping of CR components, the CR components including one or more processing components and one or more memory components, an individual processing component including one of a MTP, a tile or a core, and an individual memory component including a memory circuitry.

Example 38 includes the subject matter of any one of Examples 34-37, wherein the tile fit policy is a second tile fit policy, the processing circuitry to determine the second tile fit policy by changing a first tile fit policy to the second tile fit policy based on data from the one or more monitoring units.

Example 39 includes the subject matter of Example 38, wherein the respective groupings of CR components is a second respective groupings of CR components, the processing circuitry to determine the second tile fit policy by performing a recomposition of the CRs, performing the recomposition including changing a first respective groupings of CR components, based on data from the one or more monitoring units, to the second respective groupings of CR components.

Example 40 includes the subject matter of Example 39, wherein performing the recomposition includes splitting CR components, prior to deployment of the WL, from at least one grouping of the first respective groupings to determine the second respective groupings of CR components.

Example 41 includes the subject matter of Example 39, wherein performing the recomposition includes, during deployment of the WL, releasing CR components, from at least one grouping of the first respective groupings to determine the second respective groupings of CR components.

Example 42 includes the subject matter of any one of Examples 40 and 41, wherein the processing circuitry is to perform the recomposition based on monitoring analytics data, the monitoring analytics data based on respective usabilities of respective ones of the CR components.

Example 43 includes the subject matter of Example 42, wherein individual ones of the respective usabilities are based on a weighted sum of different types of CR information for a corresponding one of the CR components.

Example 44 includes the subject matter of Example 42, wherein individual ones of the respective usabilities are based on cost functions of releasing CR components from the first respective groupings of CR components.

Example 45 includes the subject matter of any one of Examples 24-44, the computing node to further implement one of an orchestration block of the computing network, or at least one of an operating system block or server functions.

Example 46 includes the subject matter of any one of Examples 24-45, wherein the communication interface includes at least one of a wireless or a wired interface.

Example 47 includes a product including one or more tangible computer-readable non-transitory storage media comprising computer-executable instructions operable to, when executed by a processing circuitry of a computing node of a computing network, cause the processing circuitry to implement operations comprising: receiving a first workload (WL) package including a WL; determine a first computing resource (CR) metadata corresponding to the WL; recomposing the first WL package into a second WL package, the second WL package including the WL and second CR metadata different from the first CR metadata, the second CR metadata being based at least in part on CR information regarding a server architecture onto which the WL is to be deployed, the second CR metadata further to indicate one or more processors of the server architecture onto which the WL is to be deployed; and sending the second WL package to one or more processors of the server architecture to cause deployment of the WL thereon.

Example 48 includes the subject matter of Example 47, wherein the CR information includes information on individual ones of the one or more processors, and on individual ones of interconnects between the one or more processors.

Example 49 includes the subject matter of Example 48, wherein the interconnects include respective embedded multi-die interconnect bridges.

Example 50 includes the subject matter of any one of Examples 47-49, wherein the CR information includes at least one of number of processors, number of cores per processor, memory size per processor, memory size per core, processor clock speed, core clock speed, number of memory controllers per processor, number of memory controllers per core, shared memory size between processors, shared memory size between cores, number of channels per memory controller, interconnect bandwidth between processors, interconnect communication latency between processors, number of accelerators per processor, number of accelerators per core, cryptographic speed per accelerator, compression speed per processor, compression speed per core, decompression speed per processor, decompression speed per core, or capability regarding machine-learning processing.

Example 51 includes the subject matter of any one of Examples 47-50, wherein the CR information includes dynamic CR information, the dynamic CR information including at least one of: power consumption per processor, power consumption per core, temperature per processor, temperature per core, humidity per processor, humidity per core, voltage per processor, voltage per core, fan speed per processor, execution time for a given WL per processor, execution time for a given WL per core, memory access response time per processor, memory access response time per core, WL deployment response time per processor, WL deployment response time per core, wear-and-tear per processor, wear-and-tear per core, or battery life per processor.

Example 52 includes the subject matter of Example 47, wherein: the one or more processors include a plurality of multi-tile processors (MTPs), individual ones of the MTPs including a plurality of tiles, individual ones of the tiles including one or more cores and one or more memory circuitries coupled to the one or more cores; and the CR information includes information regarding at least one of individual ones of the one or more tiles or individual ones of the one or more cores of said individual ones of the tiles.

Example 53 includes the subject matter of Example 52, wherein the CR information includes at least one of number of MTPs, number of tiles per MPT, number of cores per tile, memory size per MTP, memory size per tile, memory size per core, MTP clock speed, tile clock speed, core clock speed, number of memory controllers per MTP, number of memory controllers per tile, number of memory controllers per core, shared memory size between MTPs, shared memory size between tiles, shared memory size between cores, number of channels per memory controller, interconnect communication bandwidth between MTPs, interconnect communication bandwidth between tiles, interconnect communication bandwidth between cores, interconnect communication latency between MTPs, interconnect communication latency between tiles, interconnect communication latency between cores, number of accelerators per MTP, number of accelerators per tile, number of accelerators per core, cryptographic speed per accelerator, compression speed per MTP, compression speed per tile, compression speed per core, decompression speed per MTP, decompression speed per tile, decompression speed per core, or capability regarding machine-learning processing.

Example 54 includes the subject matter of Example 53, wherein the CR information further includes dynamic CR information, the dynamic CR information including: power consumption per MTP, power consumption per tile, power consumption per core, temperature per MTP, temperature per tile, temperature per core, humidity per MTP, humidity per tile, humidity per core, voltage per MTP, voltage per tile, voltage per core, fan speed per MTP, execution time for a given WL per MTP, execution time for a given WL per tile, execution time for a given WL per core, memory access response time per MTP, memory access response time per tile, memory access response per core, WL deployment response time per MTP, WL deployment response time per tile, WL deployment response time per core, wear-and-tear per MTP, wear-and-tear per tile, wear-and-tear per core, or battery life per MTP.

Example 55 includes the subject matter of any one of Examples 51 and 54, wherein the wear-and-tear includes information based on at least one of memory bandwidth availability, number of memory misses, number of WLs deployed per time unit, number of hardware errors, percent of maximum compute headroom being used, memory latency, overclocking, transistor aging, voltage spike, temperature spike, core utilization, one or more Reliability, Availability and Serviceability (RAS) indicators, workload key performance indicators (KPIs), power utilization, cache utilization, or hours used.

Example 56 includes the subject matter of Example 55, the computing node further including one or more monitoring units to determine the dynamic CR parameters, the operations further including accessing the dynamic CR parameters from the one or more monitoring units.

Example 57 includes the subject matter of Example 56, the operations further including accessing a tile fit policy to recompose the first WL package into the second WL package, the tile fit policy to indicate a mapping between respective types of WLs and respective CRs of the server architecture onto which the respective types of WLs are to be deployed.

Example 58 includes the subject matter of Example 57, wherein the tile fit policy is based on data from the one or more monitoring units and determined based on prior deployments of WLs at the server architecture.

Example 59 includes the subject matter of Example 58, wherein the data from the one or more monitoring units includes dynamic CR parameters.

Example 60 includes the subject matter of Example 58, wherein the respective CRs of the tile fit policy include respective groupings of CR components to which respective types of WLs are mapped, an individual grouping of CR components, the CR components including one or more processing components and one or more memory components, an individual processing component including one of a MTP, a tile or a core, and an individual memory component including a memory circuitry.

Example 61 includes the subject matter of any one of Examples 57-60, wherein the tile fit policy is a second tile fit policy, the operations further including determining the second tile fit policy by changing a first tile fit policy to the second tile fit policy based on data from the one or more monitoring units.

Example 62 includes the subject matter of Example 61, wherein the respective groupings of CR components is a second respective groupings of CR components, the operations including determining the second tile fit policy by performing a recomposition of the CRs, performing the recomposition including changing a first respective groupings of CR components, based on data from the one or more monitoring units, to the second respective groupings of CR components.

Example 63 includes the subject matter of Example 62, wherein performing the recomposition includes splitting CR components, prior to deployment of the WL, from at least one grouping of the first respective groupings to determine the second respective groupings of CR components.

Example 64 includes the subject matter of Example 62, wherein performing the recomposition includes, during deployment of the WL, releasing CR components, from at least one grouping of the first respective groupings to determine the second respective groupings of CR components.

Example 65 includes the subject matter of any one of Examples 53 and 54, the operations including performing the recomposition based on monitoring analytics data, the monitoring analytics data based on respective usabilities of respective ones of the CR components.

Example 66 includes the subject matter of Example 65, wherein individual ones of the respective usabilities are based on a weighted sum of different types of CR information for a corresponding one of the CR components.

Example 67 includes the subject matter of Example 65, wherein individual ones of the respective usabilities are based on cost functions of releasing CR components from the first respective groupings of CR components.

Example 68 includes the subject matter of any one of Examples 47-67, the computing node to further implement one of an orchestration block of the computing network, or at least one of an operating system block or server functions.

Example 69 includes the subject matter of any one of Examples 47-48, further comprising a communication interface to communicate with another computing node of the network, the communication interface including at least one of a wireless or a wired interface.

Example 70 includes a method to be performed at a computing node of a computing network, the method comprising: receiving a first workload (WL) package including a WL; determine a first computing resource (CR) metadata corresponding to the WL; recomposing the first WL package into a second WL package, the second WL package including the WL and second CR metadata different from the first CR metadata, the second CR metadata being based at least in part on CR information regarding a server architecture onto which the WL is to be deployed, the second CR metadata further to indicate one or more processors of the server architecture onto which the WL is to be deployed; and sending the second WL package to one or more processors of the server architecture to cause deployment of the WL thereon.

Example 71 includes the subject matter of Example 70, wherein the CR information includes information on individual ones of the one or more processors, and on individual ones of interconnects between the one or more processors.

Example 72 includes the subject matter of Example 71, wherein the interconnects include respective embedded multi-die interconnect bridges.

Example 73 includes the subject matter of any one of Examples 70-72, wherein the CR information includes at least one of number of processors, number of cores per processor, memory size per processor, memory size per core, processor clock speed, core clock speed, number of memory controllers per processor, number of memory controllers per core, shared memory size between processors, shared memory size between cores, number of channels per memory controller, interconnect bandwidth between processors, interconnect communication latency between processors, number of accelerators per processor, number of accelerators per core, cryptographic speed per accelerator, compression speed per processor, compression speed per core, decompression speed per processor, decompression speed per core, or capability regarding machine-learning processing.

Example 74 includes the subject matter of any one of Examples 70-73, wherein the CR information includes dynamic CR information, the dynamic CR information including at least one of: power consumption per processor, power consumption per core, temperature per processor, temperature per core, humidity per processor, humidity per core, voltage per processor, voltage per core, fan speed per processor, execution time for a given WL per processor, execution time for a given WL per core, memory access response time per processor, memory access response time per core, WL deployment response time per processor, WL deployment response time per core, wear-and-tear per processor, wear-and-tear per core, or battery life per processor.

Example 75 includes the subject matter of Example 70, wherein: the one or more processors include a plurality of multi-tile processors (MTPs), individual ones of the MTPs including a plurality of tiles, individual ones of the tiles including one or more cores and one or more memory circuitries coupled to the one or more cores; and the CR information includes information regarding at least one of individual ones of the one or more tiles or individual ones of the one or more cores of said individual ones of the tiles.

Example 76 includes the subject matter of Example 75, wherein the CR information includes at least one of number of MTPs, number of tiles per MPT, number of cores per tile, memory size per MTP, memory size per tile, memory size per core, MTP clock speed, tile clock speed, core clock speed, number of memory controllers per MTP, number of memory controllers per tile, number of memory controllers per core, shared memory size between MTPs, shared memory size between tiles, shared memory size between cores, number of channels per memory controller, interconnect communication bandwidth between MTPs, interconnect communication bandwidth between tiles, interconnect communication bandwidth between cores, interconnect communication latency between MTPs, interconnect communication latency between tiles, interconnect communication latency between cores, number of accelerators per MTP, number of accelerators per tile, number of accelerators per core, cryptographic speed per accelerator, compression speed per MTP, compression speed per tile, compression speed per core, decompression speed per MTP, decompression speed per tile, decompression speed per core, or capability regarding machine-learning processing.

Example 77 includes the subject matter of Example 76, wherein the CR information further includes dynamic CR information, the dynamic CR information including: power consumption per MTP, power consumption per tile, power consumption per core, temperature per MTP, temperature per tile, temperature per core, humidity per MTP, humidity per tile, humidity per core, voltage per MTP, voltage per tile, voltage per core, fan speed per MTP, execution time for a given WL per MTP, execution time for a given WL per tile, execution time for a given WL per core, memory access response time per MTP, memory access response time per tile, memory access response per core, WL deployment response time per MTP, WL deployment response time per tile, WL deployment response time per core, wear-and-tear per MTP, wear-and-tear per tile, wear-and-tear per core, or battery life per MTP.

Example 78 includes the subject matter of any one of Examples 74 and 77, wherein the wear-and-tear includes information based on at least one of memory bandwidth availability, number of memory misses, number of WLs deployed per time unit, number of hardware errors, percent of maximum compute headroom being used, memory latency, overclocking, transistor aging, voltage spike, temperature spike, core utilization, one or more Reliability, Availability and Serviceability (RAS) indicators, workload key performance indicators (KPIs), power utilization, cache utilization, or hours used.

Example 79 includes the subject matter of Example 78, further including accessing the dynamic CR parameters from one or more monitoring units.

Example 80 includes the subject matter of Example 79, further including accessing a tile fit policy to recompose the first WL package into the second WL package, the tile fit policy to indicate a mapping between respective types of WLs and respective CRs of the server architecture onto which the respective types of WLs are to be deployed.

Example 81 includes the subject matter of Example 80, wherein the tile fit policy is based on data from the one or more monitoring units and determined based on prior deployments of WLs at the server architecture.

Example 82 includes the subject matter of Example 81, wherein the data from the one or more monitoring units includes dynamic CR parameters.

Example 83 includes the subject matter of Example 81, wherein the respective CRs of the tile fit policy include respective groupings of CR components to which respective types of WLs are mapped, an individual grouping of CR components, the CR components including one or more processing components and one or more memory components, an individual processing component including one of a MTP, a tile or a core, and an individual memory component including a memory circuitry.

Example 84 includes the subject matter of any one of Examples 80-83, wherein the tile fit policy is a second tile fit policy, further including determining the second tile fit policy by changing a first tile fit policy to the second tile fit policy based on data from the one or more monitoring units.

Example 85 includes the subject matter of Example 84, wherein the respective groupings of CR components is a second respective groupings of CR components, the method including determining the second tile fit policy by performing a recomposition of the CRs, performing the recomposition including changing a first respective groupings of CR components, based on data from the one or more monitoring units, to the second respective groupings of CR components.

Example 86 includes the subject matter of Example 85, wherein performing the recomposition includes splitting CR components, prior to deployment of the WL, from at least one grouping of the first respective groupings to determine the second respective groupings of CR components.

Example 87 includes the subject matter of Example 85, wherein performing the recomposition includes, during deployment of the WL, releasing CR components, from at least one grouping of the first respective groupings to determine the second respective groupings of CR components.

Example 88 includes the subject matter of any one of Examples 76 and 77, the method including performing the recomposition based on monitoring analytics data, the monitoring analytics data based on respective usabilities of respective ones of the CR components.

Example 89 includes the subject matter of Example 88, wherein individual ones of the respective usabilities are based on a weighted sum of different types of CR information for a corresponding one of the CR components.

Example 90 includes the subject matter of Example 88, wherein individual ones of the respective usabilities are based on cost functions of releasing CR components from the first respective groupings of CR components.

Example 91 includes the subject matter of any one of Examples 70-90, further including implementing one of the orchestration block, or at least one of an operating system block or server functions.

Example 92 includes the subject matter of any one of Examples 70-71, further including communicating, at least one of wirelessly or by way of a wired interface, with another computing node of the network.

Example 93 includes an apparatus including means for performing a method according to any one of claims 70-92.

Example 94 includes a computer readable storage medium including code which, when executed, is to cause a machine to perform any of the methods of claims 70-92.

Example 95 includes a method to perform the functionalities of any one of Examples 70-92.

Example 96 includes a non-transitory computer-readable storage medium comprising instructions stored thereon, that when executed by one or more processors of a packet processing device, cause the one or more processors to perform the functionalities of any one of Examples 70-92.

Example 97 includes means to perform the functionalities of any one of Examples 70-92.

1. An apparatus of a computing node of a computing network, the apparatus including:
an input and an output; and
a processing circuitry coupled to the input and to the output, the processing circuitry to:
receive, at the input, a first workload (WL) package including a WL;
determine a first computing resource (CR) metadata corresponding to the WL;
recompose the first WL package into a second WL package, the second WL package including the WL and second CR metadata different from the first CR metadata, the second CR metadata being based at least in part on CR information regarding a server architecture onto which the WL is to be deployed, the second CR metadata further to indicate one or more processors of the server architecture onto which the WL is to be deployed; and
send, from the output, the second WL package to one or more processors of the server architecture to cause deployment of the WL thereon.

2. The apparatus of claim 1, wherein the CR information includes information on individual ones of the one or more processors, and on individual ones of interconnects between the one or more processors.

3. The apparatus of claim 1, wherein:
the one or more processors include a plurality of multi-tile processors (MTPs), individual ones of the MTPs including a plurality of tiles, individual ones of the tiles including one or more cores and one or more memory circuitries coupled to the one or more cores; and
the CR information includes information regarding at least one of individual ones of the one or more tiles or individual ones of the one or more cores of said individual ones of the tiles.

4. The apparatus of claim 3, wherein the CR information includes at least one of number of MTPs, number of tiles per MPT, number of cores per tile, memory size per MTP, memory size per tile, memory size per core, MTP clock speed, tile clock speed, core clock speed, number of memory controllers per MTP, number of memory controllers per tile, number of memory controllers per core, shared memory size between MTPs, shared memory size between tiles, shared memory size between cores, number of channels per memory controller, interconnect communication bandwidth between MTPs, interconnect communication bandwidth between tiles, interconnect communication bandwidth between cores, interconnect communication latency between MTPs, interconnect communication latency between tiles, interconnect communication latency between cores, number of accelerators per MTP, number of accelerators per tile, number of accelerators per core, cryptographic speed per accelerator, compression speed per MTP, compression speed per tile, compression speed per core, decompression speed per MTP, decompression speed per tile, decompression speed per core, or capability regarding machine-learning processing.

5. The apparatus of claim 4, wherein the CR information further includes dynamic CR information, the dynamic CR information including: power consumption per MTP, power consumption per tile, power consumption per core, temperature per MTP, temperature per tile, temperature per core, humidity per MTP, humidity per tile, humidity per core, voltage per MTP, voltage per tile, voltage per core, fan speed per MTP, execution time for a given WL per MTP, execution time for a given WL per tile, execution time for a given WL per core, memory access response time per MTP, memory access response time per tile, memory access response per core, WL deployment response time per MTP, WL deployment response time per tile, WL deployment response time per core, wear-and-tear per MTP, wear-and-tear per tile, wear-and-tear per core, or battery life per MTP.

6. The apparatus of claim 5, wherein the wear-and-tear includes information based on at least one of memory bandwidth availability, number of memory misses, number of WLs deployed per time unit, number of hardware errors, percent of maximum compute headroom being used, memory latency, overclocking, transistor aging, voltage spike, temperature spike, core utilization, one or more Reliability, Availability and Serviceability (RAS) indicators, workload key performance indicators (KPIs), power utilization, cache utilization, or hours used.

7. The apparatus of claim 6, further including one or more monitoring units to determine the dynamic CR parameters, the processing circuitry to access the dynamic CR parameters from the one or more monitoring units.

8. The apparatus of claim 7, wherein the processing circuitry is to access a tile fit policy to recompose the first WL package into the second WL package, the tile fit policy to indicate a mapping between respective types of WLs and respective CRs of the server architecture onto which the respective types of WLs are to be deployed.

9. The apparatus of claim 8, wherein the tile fit policy is based on data from the one or more monitoring units and determined based on prior deployments of WLs at the server architecture.

10. The apparatus of claim 9, wherein the data from the one or more monitoring units includes dynamic CR parameters.

11. A computing node of a computing network, the computing node including:
a communication interface to communicate with other computing nodes of the computing network; and
a processing circuitry coupled to the communication interface, the processing circuitry to:
receive, at the input, a first workload (WL) package including a WL;
determine a first computing resource (CR) metadata corresponding to the WL;
recompose the first WL package into a second WL package, the second WL package including the WL and second CR metadata different from the first CR metadata, the second CR metadata being based at least in part on CR information regarding a server architecture onto which the WL is to be deployed, the second CR metadata further to indicate one or more processors of the server architecture onto which the WL is to be deployed; and
send, from the output, the second WL package to one or more processors of the server architecture to cause deployment of the WL thereon.

12. The computing node of claim 11, wherein the CR information includes information on individual ones of the one or more processors, and on individual ones of interconnects between the one or more processors.

13. A non-transitory computer-readable storage medium comprising instructions stored thereon that, when executed by one or more processors of a data center, cause the one or more processors to perform operations including:
receiving a first workload (WL) package including a WL;
determining a first computing resource (CR) metadata corresponding to the WL;
recomposing the first WL package into a second WL package, the second WL package including the WL and second CR metadata different from the first CR metadata, the second CR metadata being based at least in part on CR information regarding a server architecture onto which the WL is to be deployed, the second CR metadata further to indicate one or more processors of the server architecture onto which the WL is to be deployed; and
sending the second WL package to one or more processors of the server architecture to cause deployment of the WL thereon.

14. The computer-readable storage medium of claim 13, wherein the CR information includes information on individual ones of the one or more processors, and on individual ones of interconnects between the one or more processors.

15. The computer-readable storage medium of claim 13, wherein the CR information includes at least one of number of processors, number of cores per processor, memory size per processor, memory size per core, processor clock speed, core clock speed, number of memory controllers per processor, number of memory controllers per core, shared memory size between processors, shared memory size between cores, number of channels per memory controller, interconnect bandwidth between processors, interconnect communication latency between processors, number of accelerators per processor, number of accelerators per core, cryptographic speed per accelerator, compression speed per processor, compression speed per core, decompression speed per processor, decompression speed per core, or capability regarding machine-learning processing.

16. The computer-readable storage medium of claim 13, wherein the CR information includes dynamic CR information, the dynamic CR information including at least one of: power consumption per processor, power consumption per core, temperature per processor, temperature per core, humidity per processor, humidity per core, voltage per processor, voltage per core, fan speed per processor, execution time for a given WL per processor, execution time for a given WL per core, memory access response time per processor, memory access response time per core, WL deployment response time per processor, WL deployment response time per core, wear-and-tear per processor, wear-and-tear per core, or battery life per processor.

17. The computer-readable storage medium claim 16, wherein the wear-and-tear includes information based on at least one of memory bandwidth availability, number of memory misses, number of WLs deployed per time unit, number of hardware errors, percent of maximum compute headroom being used, memory latency, overclocking, transistor aging, voltage spike, temperature spike, core utilization, one or more Reliability, Availability and Serviceability (RAS) indicators, workload key performance indicators (KPIs), power utilization, cache utilization, or hours used.

18. The computer-readable storage medium of claim 17, the operations further including accessing a CR fit policy to recompose the first WL package into the second WL package, the CR fit policy to indicate a mapping between respective types of WLs and respective CRs of the server architecture onto which the respective types of WLs are to be deployed, the CR fit policy further based on data from one or more monitoring units and determined based on prior deployments of WLs at the server architecture.

19. A method to be performed at a computing node of a computing network, the method comprising:
receiving a first workload (WL) package including a WL;
determining a first computing resource (CR) metadata corresponding to the WL;
recomposing the first WL package into a second WL package, the second WL package including the WL and second CR metadata different from the first CR metadata, the second CR metadata being based at least in part on CR information regarding a server architecture onto which the WL is to be deployed, the second CR metadata further to indicate one or more processors of the server architecture onto which the WL is to be deployed; and
sending the second WL package to one or more processors of the server architecture to cause deployment of the WL thereon.

20. The method of claim 19, wherein the CR information includes information on individual ones of the one or more processors, and on individual ones of interconnects between the one or more processors.
